(19) United States
(12) Patent Application Publication
(10) Pub. No.: US 2015/0253800 A1
(43) Pub. Date: Sep. 10, 2015

(54) Apparatus and Method for Providing Electrical Power from a Variable Power Source to an Electronic Device

(71) Applicant: Flamestower, Inc., San Francisco, CA (US)

(72) Inventor: Reza Kassayan, Atherton, CA (US)

(21) Appl. No.: 14/603,352

(22) Filed: Jan. 22, 2015

Related U.S. Application Data
(60) Provisional application No. 61/965,120, filed on Jan. 22, 2014.

(51) Int. Cl. G05F 5/00

(52) U.S. Cl. CPC G05F 5/00

(57) ABSTRACT

An electronic circuit for use with a variable electrical power source providing input power for use by an electronic device. The electronic circuit can include comparison circuitry for providing at least one transition power characteristic threshold and for comparing the input power to the at least one transition power characteristic threshold and switching circuitry for disconnecting and then reconnecting the power supply to the electronic device when the input power exceeds the at least one transition power characteristic threshold.

### CROSS REFERENCE TO RELATED APPLICATIONS

This application claims the priority of U.S. provisional application Ser. No. 61,965,120 filed Jan. 22, 2014, the entire contents of which is incorporated herein by this reference.

### TECHNICAL FIELD

The present invention relates to apparatuses and methods for managing the electrical output from a variable power source and, more particularly, for managing the electrical output from a variable power source for use in an electronic device.

### BACKGROUND

Portable electronic devices such as laptops, tablets, e-readers, smartphones and MP3 players have become ubiquitous in our everyday lives enabling users to take their data, such as files, music, contacts, e-books and videos, on the go without the need for tying directly to an electric or information-providing grid. Typically, portable electronic devices of this kind are equipped with a rechargeable power source, for example a rechargeable battery. In some instances, and due to the portability of such electronic devices, it may not always be possible or practicable to charge or recharge such electronic devices using grid-based electricity, while in other instances grid-based electricity may not available because of, for example, a power outage.

Conventional power generation devices using the electricity grid for distribution and delivery, for example steam turbine based and or renewable power generators, may not be optimal for off-grid or in the wild charging of portable electronic devices or during power outages because conventional power generation devices often include moving components that make them more complex, less portable and expensive. In addition, conventional power generation devices often have high parasitic loads to be suitable for low power generation.

Small, portable generators, for example portable generators using photovoltaics, thermoelectrics or any other electricity generating technology reliant on variable energy sources, like the sun, heat, flowing water or kinetic motion, may not be optimal for off-grid or in the wild charging of portable electronic devices or during power outages for a variety of reasons, including their inability to directly charge portable electronic devices and/or provide the maximum available energy generated by a variable power source at any given time to a portable electronic device, and their resulting reliance on intermediate storage technologies such as rechargeable batteries that increase the parasitic losses, carrying weight and cost of such generators or technology. For example, the Nomad 7 photovoltaic solar panels, sold by the Goal Zero brand owned by NRG Inc, located in Princeton, N.J. are sold for use outdoors while camping to charge portable electronic devices like mobile phones. However, in the event that a cloud passes over so as to block the solar irradiance to the panel and reduce the power generated by the panel, when the cloud moves away so as to allow full solar irradiance and a return to full power, the power management circuitry of the Nomad 7 precludes it from delivering the full power of the panel to the portable electronic device being charged. This may result in inefficient power delivery and increased time required to charge the portable electronic device.

It is also known to provide a rechargeable battery system. One such system is the Switch 8, which is used in conjunction with the Nomad 7 in order to manage the variability of the power source and reduce the above mentioned inefficiencies in device charging. However, this rechargeable battery system causes additional unnecessary cost and weight to the portable power generating system. In addition, this rechargeable battery system creates an additional charge/discharge cycle in the conversion of solar energy into electricity to charge the target portable electronic device, which contributes inefficiencies to the energy conversion process.

There remains a need to provide a power management system that can be used with variable power generators for the direct charging or powering of portable electronic devices, one that does not require the use of an intermediary rechargeable battery system but can meet the specific energy delivery requirements of electronic devices.

### BRIEF DESCRIPTION OF THE DRAWINGS

A brief description of the drawings is provided below to facilitate understanding of the present disclosure. These drawings depict only several examples in accordance with the disclosure and are, therefore, not to be considered limiting of its scope. The disclosure will be described with additional specificity and detail through use of the accompanying drawings.

FIG. 1 illustrates a block diagram of a power supply connected to a portable electronic device via the apparatus of the invention.

FIG. 2 is a block diagram of one embodiment of the apparatus of the invention of FIG. 1.

FIG. 3 is one embodiment of the electronic circuit in the apparatus of FIG. 2.

FIG. 4 is an illustration of one embodiment of the power category sensing component of the electronic circuit of FIG. 3.

FIG. 5 is an illustration of one embodiment of the shut off and switch component of the electronic circuit of FIG. 3.

FIG. 6 is an isometric view of one embodiment of a power generating apparatus incorporating the electronic circuit of the present invention.

FIG. 7 is an exploded isometric view of a portion of the power generating apparatus of FIG. 6.

Similar reference numbers may be used in different figures to denote similar components.

### DETAILED DESCRIPTION

In the following detailed description, reference is made to the accompanying drawings, which form a part hereof. In the drawings, similar symbols typically identify similar components, unless context dictates otherwise. The illustrative examples described in the detailed description and depicted in the drawings are not meant to be limiting. Other examples may be utilized, and other changes may be made, without departing from the aspects of the present disclosure as generally described herein and illustrated in the figures. Apparatuses, devices, components and electronic circuits of the invention can be arranged, substituted, combined, separated and designed in a wide variety of different configurations, all of which are implicitly contemplated herein.

Examples of electronic circuits and power management methods for converting the output of a variable power source into controlled electricity, for example for providing electrical energy to directly power or charge a portable electronic device, are described herein. One embodiment and aspect of the invention permits the direct charging of batteries in electronic devices without requiring ancillary batteries and without the electronic device holding on an initially-observed power input. For example, one embodiment and aspect of the invention permits charging of batteries in certain devices at multiple power input levels, continually testing power availability and allowing devices to reset themselves to scale from one level or threshold to another as power from a generator or variable power source changes. Uses of the invention can range from charging or powering cell phone, tablet and laptop batteries, to charging or powering radios and any other electronic device from a dedicated charging port.

In one embodiment of the invention, an electronic circuit for use with any variable power generator or electrical energy source is provided to manage and deliver the electrical energy from the generator or other power source to a portable or other electronic device. In one embodiment, the electronic circuit can include voltage management circuitry, a power category sensing circuitry or other component to accurately match available power from the power source to quantized power levels inherent to electronic devices. In one embodiment, the electronic circuit includes a device disconnect component that disconnects the electronic device from the generator in order to re-establish electrical energy delivery to the electronic device in a new, higher quantized power level. In one embodiment, the electronic circuit includes a gradual voltage dropping component to slow the voltage drop of the power being delivered to the electronic device as the electronic device attempts to secure the highest available current. In one embodiment, the voltage drop ceases when the electronic device settles on an available power category.

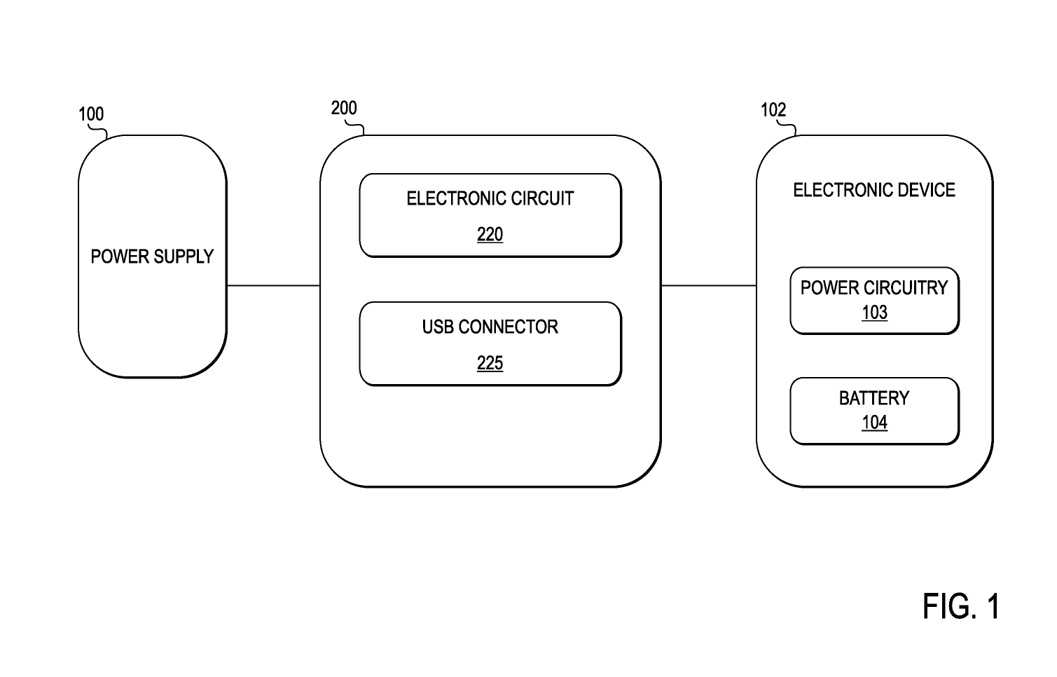

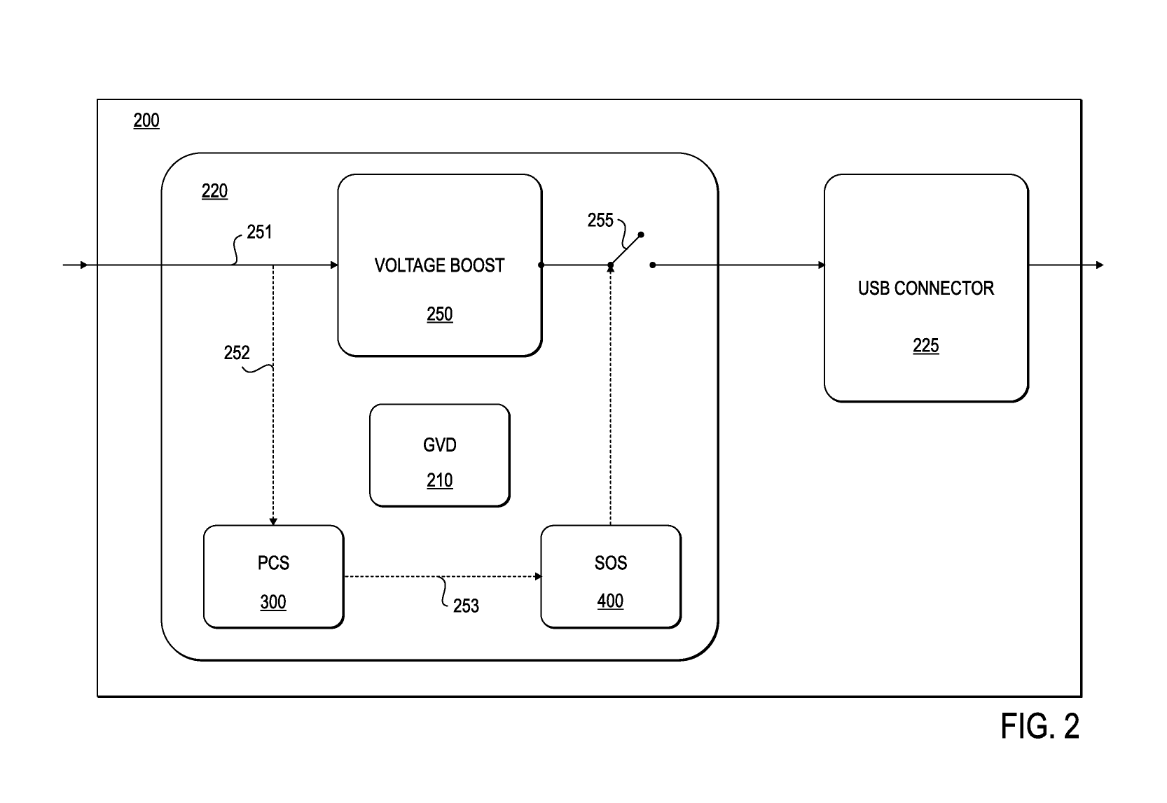

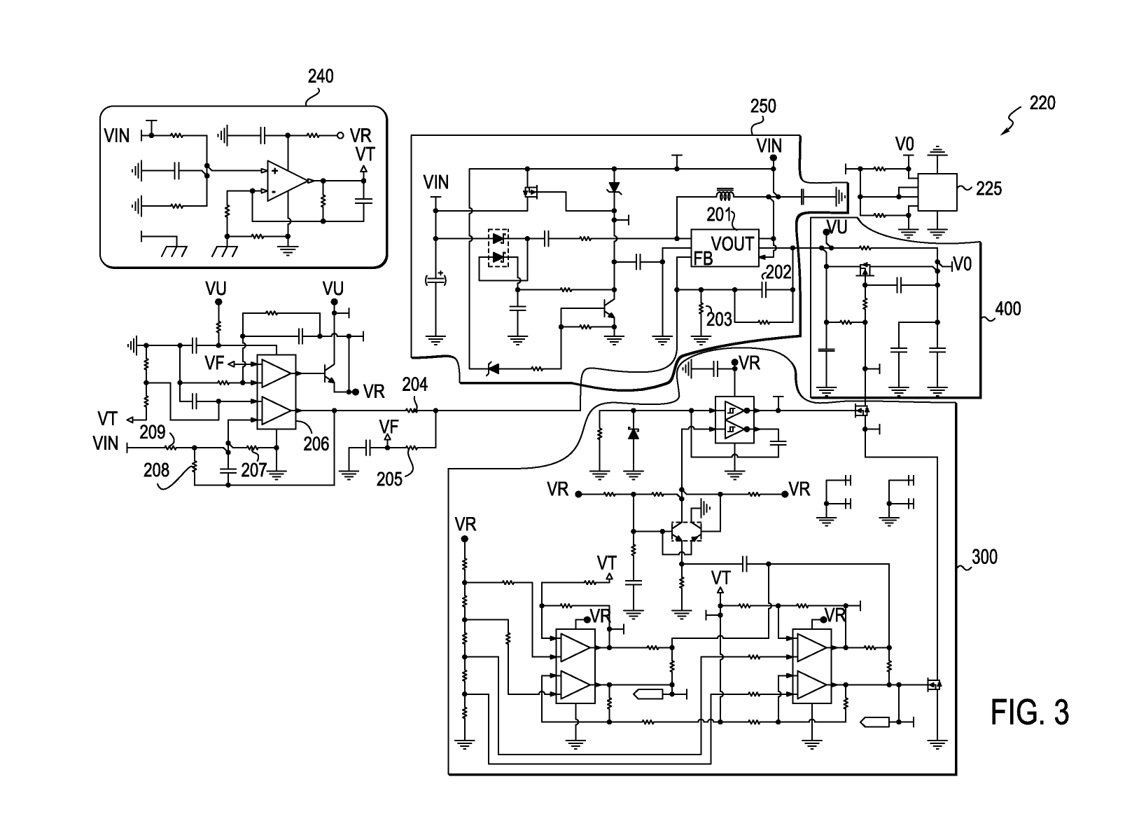

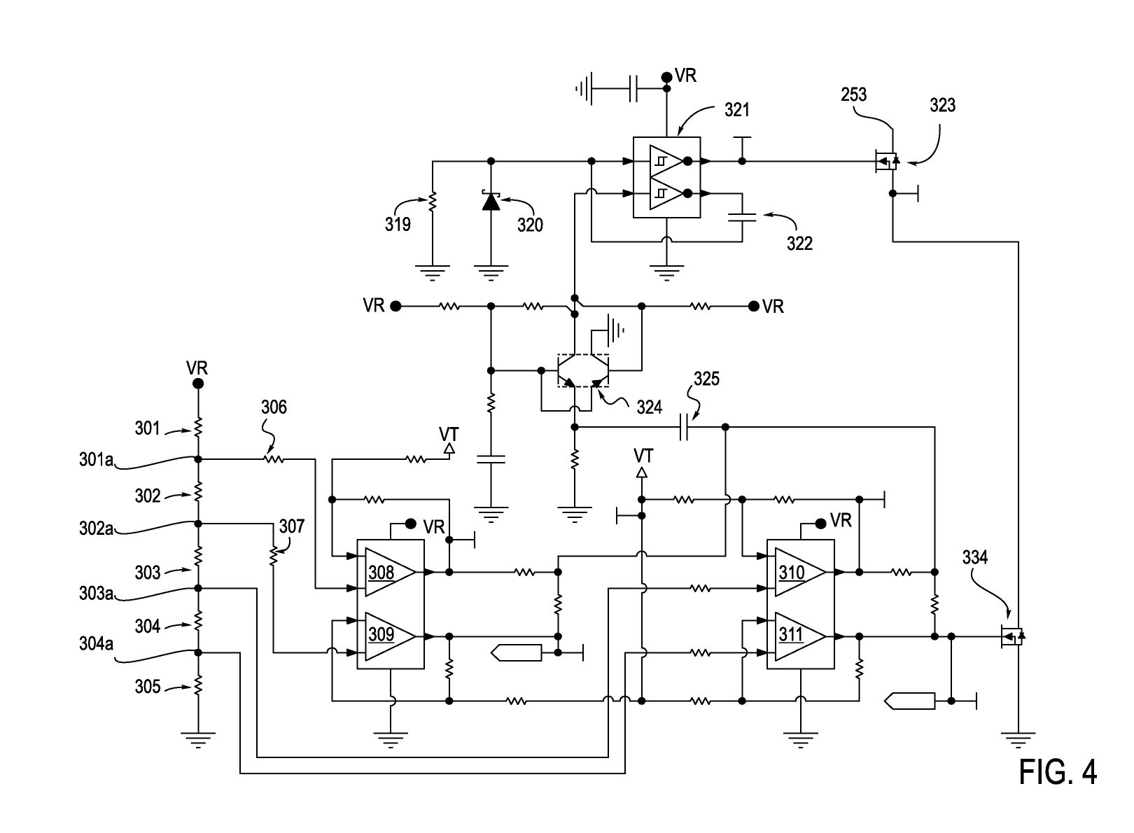

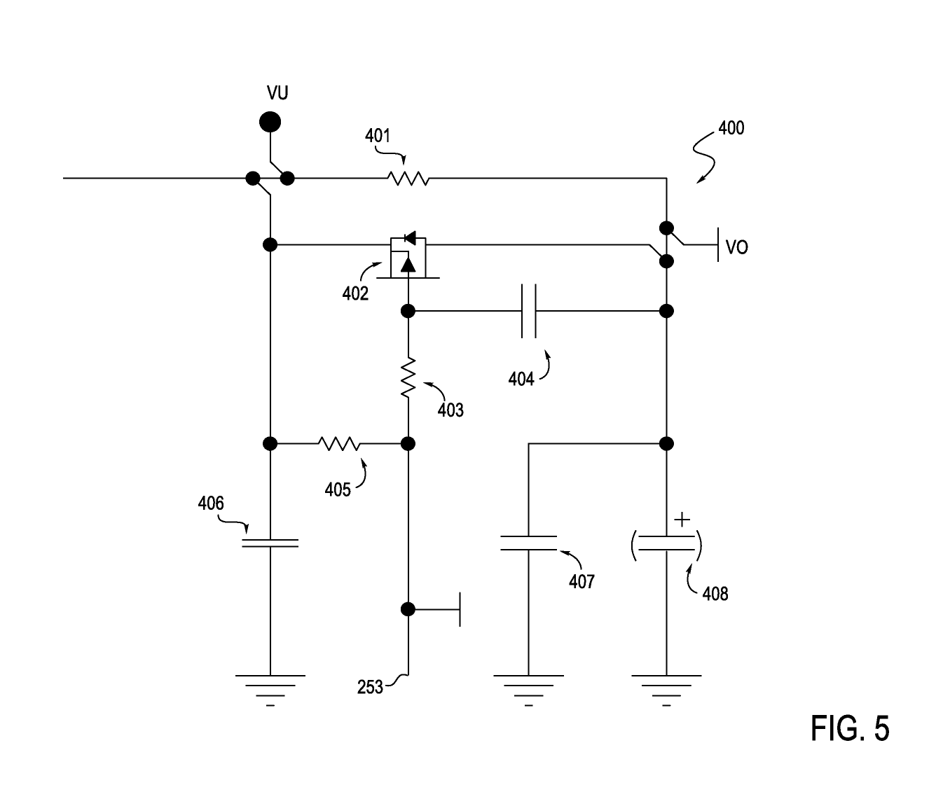

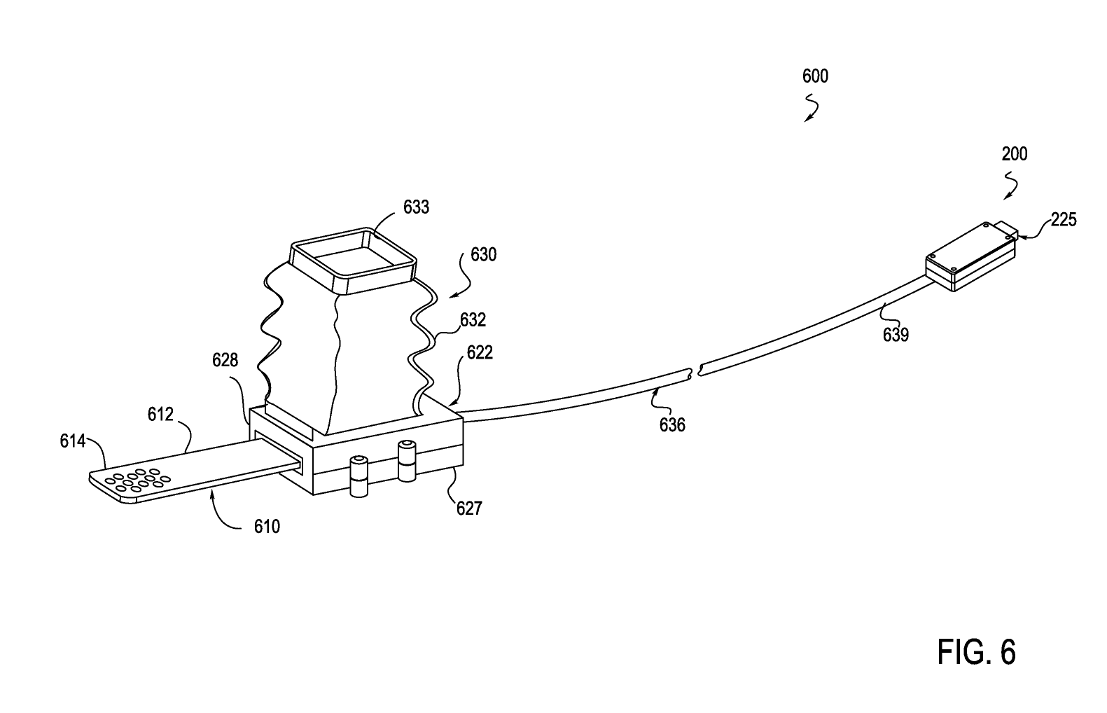

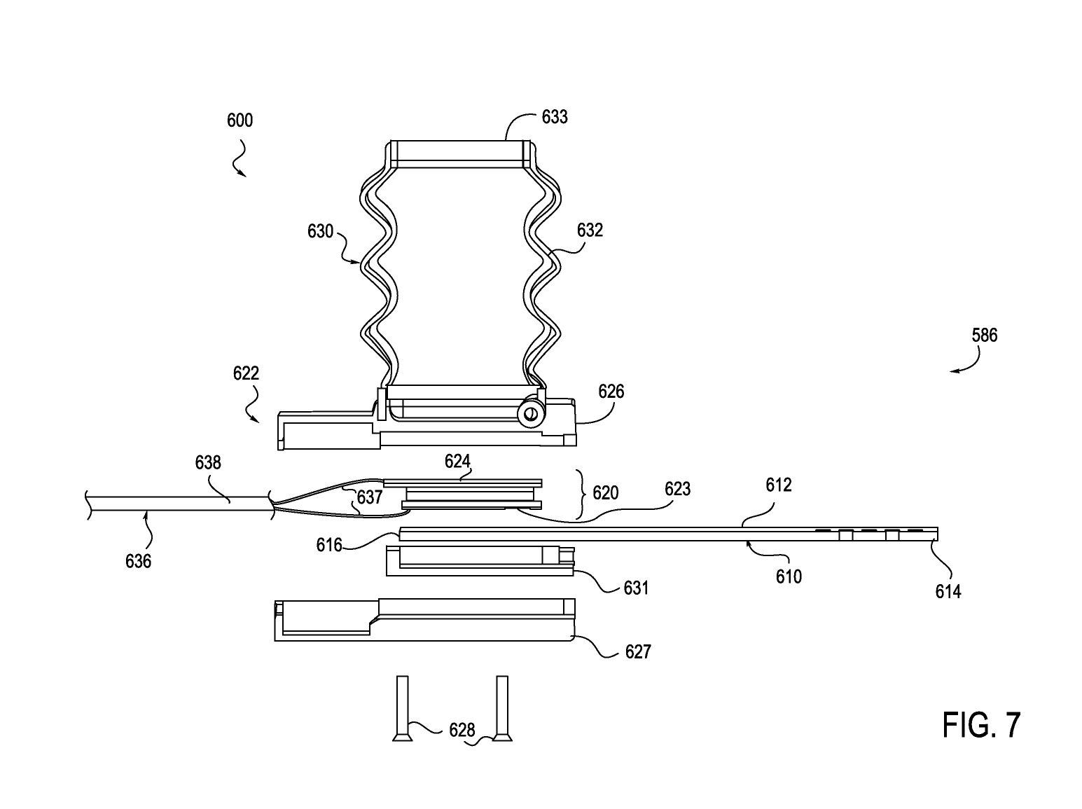

In one aspect of the invention, an apparatus 200 for providing stable power from a variable electrical power source is provided. FIG. 1 is a block diagram showing the path of power flow from a power supply 100, through an apparatus 200 of the invention, and then delivered to an electronic device 102. One embodiment of the apparatus of the invention is illustrated in the block diagram of FIG. 2 and includes an electronic circuit or device 220 and a suitable electrical connector 225. One embodiment of the electronic circuit 220 of the invention is illustrated in the diagram of FIG. 3. FIGS. 4-5 show embodiments of certain components in the electronic circuit 220 of the apparatus 200, and include enlarged views of some of the individual components of the apparatus. FIGS. 6-7 illustrate apparatus 200 integrated into an exemplary device having a suitable variable electrical power source such as a portable power generator. In the illustrated embodiment of FIGS. 6-7, the portable power generator uses thermoelectric modules to convert the heat energy from open or other energy sources such as fires into electricity for any suitable purpose, for example to power or charge electronic devices that may include batteries.

In one embodiment of the invention, electronic circuit 220 of the apparatus 200 can be comprised of individual circuit elements mounted or attached to a printed circuit board or built into one or more integrated circuits (see FIGS. 3-5). The apparatus 200 can be positioned electronically between a variable electrical power supply 100 and any suitable electronic device 102, all of which can be connected electronically by wires or other suitable electrical leads internal or external to the various components. In one embodiment, the electronic device 102 can contain internal circuitry 103 to manage the power flow and power characteristics such as voltage and current incident to the electronic device, which circuitry may be connected to a battery 104 for energy storage. Other circuitry and electronic elements can be included in the electronic device and are omitted in the figures for simplicity. The electronic device can be of any suitable type, and in one embodiment is a portable electronic device. Exemplary portable electronic devices include phones, smartphones, mobile phones, satellite phones, portable phones, tablets, notebooks, laptops, computers, gaming devices, navigation devices, cameras, watches, wearable electronic devices and personal electronic equipment. In one embodiment, the apparatus 200 includes a suitable electrical connector, such as a Universal Serial Bus (USB) connector 225, which can interface with multiple electronic devices. A suitable USB connector can adhere to the USB standard or be designed to interface with USB connections.

In one embodiment, electronic circuit 220 may include a plurality of circuitry elements, each comprised in turn by one or multiple individual analog or other suitable circuit elements. In one embodiment, electronic circuit 220 includes voltage management or voltage boost circuitry 250 to convert variable voltage levels to a single output voltage value, power category sensing (“PCS”) circuitry 300 to continually test and quantify the available power 251 provided by the generator or other suitable variable electrical power source 100 and compare it to predetermined power levels, shut off and switch regulation (“SOS”) circuitry 400 to control the electrical connection between the power 251 from the power source 100 to the electronic device 102, and gradual voltage drop (“GVD”) circuitry 210 to regulate any drop in the voltage being provided by apparatus 200 to the electronic device 201 (see FIG. 2). In one embodiment, apparatus 200 and electronic circuit 220 includes at least PCS circuitry, SOS circuitry and GVD circuitry. In one embodiment, the electronic circuit 220 additionally includes available power measurement circuitry 240. The circuitry of circuit 220, which may include some or all of available power measurement circuitry 240, voltage boost circuitry 250, PCS circuitry 300, SOS circuitry 400, and GVD circuitry 210 circuitry or components can all be included on one or more printed circuit board, and in one embodiment can each be created from multiple analog circuit components or may be incorporated into one or more integrated circuits.

In one embodiment of the invention, voltage boost circuitry 250 is included in electronic circuit 220 to modify the voltage provided by the power supply 100 for delivery to the electronic device 102. In one embodiment, the voltage from the power supply is modified to meet USB standards. The incident power 251 from the power supply 100, which includes voltage VIN in the figures, is sent directly to the voltage boost circuitry 250. A reference voltage 252, VR in the figures, is provided from the incident power 251 and relayed to the PCS circuitry 300.

The incident power 251 from the power supply 100 is additionally provided to available power measurement circuitry 240, which dynamically detecting the voltage and current being provided by the variable electrical power source. Circuitry 240 can include calculation circuitry that utilizes the voltage and current components of the incident power to provide a calculated variable voltage that correlates to the incident power 251. One embodiment of available power measurement circuitry 240 is illustrated in FIG. 3, where the voltage component of the incident power 251 is shown as VIN and the variable voltage derived from circuitry 240 is shown as VT. Reference voltage VR, discussed above, is additionally shown in FIG. 3.

The PCS circuitry 300, which can also be referred to as power level sensor, voltage level sensor or current level sensor circuitry, can in one embodiment continually test and quantify the available power 251 provided by the generator or other suitable variable electrical power source 100 and compare it to predetermined power levels (see FIGS. 3-4). In one embodiment, the PCS circuitry 300 includes comparison circuitry for providing at least one transition power characteristic threshold and comparing the input power, input current and/or input voltage to the at least one transition power characteristic threshold. The electrical energy levels defined by the power category sensing component 300 can in one embodiment be defined to match the electrical energy levels of one or more specified portable or other electronic devices to be utilized with apparatus 200. In one embodiment, the PCS circuitry correlates a plurality of reference voltages to a respective plurality of power or current level thresholds or transitions inherent to the specified electronic devices. In one embodiment, four voltage thresholds or transitions are quantified by a resistor set 301-305, the value of each of which resistors may be provided to define the different predetermined voltage thresholds for the electronic device being powered or charged (see for example FIG. 4). In one embodiment, the resistor bridge formed by resistor set 301-305 is disposed between reference voltage VR and ground, with the voltage at each junction dropping by the voltage drop across the upstream resistor. Thus, the voltages at junctions 301a, 302a, 303a and 304a sequentially decrease by the amount of the voltage drop across the respective resistors 301-304. The values of resistors 301-305 can be chosen so that voltages 301a-304a correspond to predetermined power, current or voltage thresholds or transitions, such as power, current or voltage thresholds that map to or approximate power, current or voltage thresholds or transitions of the one or more electronic devices 102 to be utilized with apparatus 200. For example, voltage 304a correlates to a first or lowest power, current or voltage threshold or transition, voltage 303a correlates to a second or intermediate power, current or voltage threshold or transition, voltage 302a correlates to a third or other intermediate power, current or voltage threshold or transition and voltage 301 a correlates to a fourth or high power, current or voltage threshold or transition. In one embodiment, for example illustrated herein, each voltage 301a-304a correlates or corresponds to a power or current transition. The resulting signals through the resistor set, which includes voltages 301a-304a, are delivered to corresponding inputs on operational amplifiers 308, 309, 310 and 311. The number of amplifiers can vary, and in one embodiment the number of amplifiers equals the number of junction voltages measured in resistor bridge 301-305.

Each amplifier 308-311 compares the respective junction voltage 301a-304a to the variable voltage VT and changes state when the variable voltage exceeds the respective junction voltage. Thus, amplifier 311 compares junction voltage 304a to variable voltage VT and changes state when the variable voltage increases above the junction voltage 304a. Similarly, amplifier 310 compares junction voltage 303a to variable voltage VT and changes state when the variable voltage VT increases above the junction voltage 303a.

Hysteresis can be added on margins of each boundary of the signals to prevent oscillations when input voltage changes are slow, and additional hysteresis may be applied through additional resistor elements in the PCS circuitry 300.

Each transition of the variable power source 100, also referred to as the incident power source 100, over a power threshold or transition from one defined power category to another category may be recorded in a transistor 324 and then through a capacitor 322. If the recorded transition is from a higher power category to a lower power category, the transition may not produce any output from the PCS circuitry. If the transition is from a lower power category to a higher power category, an electrical pulse may be generated by components 319-322 of the PCS circuitry, which pulse is then fed to a transistor 323 to inverse its polarity. A final pulse output 253 from the drain pin on transistor 323 is then relayed to the SOS circuitry 400 (see FIGS. 4-5).

In one embodiment, SOS circuitry 400 includes switching circuitry for disconnecting and then reconnecting the power supply to the electronic device when the input power, input current and/or input voltage exceeds an at least one transition power characteristic threshold. Upon release of the final pulse output 253 from transistor 323 described above, the pulse 253 may deactivate the gate in transistor 402 of the SOS circuitry 400, disconnecting the current that passes through transistor 402 and thereby disconnecting the power 251 from the power source 100 to the electronic device 102 (see FIGS. 3 and 5). In this manner, the SOS circuitry 400 functions as an electrical switch 255, as shown in FIG. 2, that autonomously disconnects and connects the power supply 100 to the electronic device 102. The duration of disconnect is adjusted by the upper inverter in inverter 321 and resistor 319, diode 320 and capacitor 322. In one embodiment, diode 320 is a Schottky diode. Upon disconnection through transistor 402, diode 320 discharges capacitor 322 and the upper inverter in inverter 321 measures the time that capacitor 322 recharges through resistor 319. The time of disconnect is approximately T=1.2*(resistor value of resistor 319)*(capacitance of capacitor 322). In one embodiment, the value T=1.2*(3.3 MOhm)*(1 uF)=3.96 seconds, which time value has some tolerance and can be to some degree different than the calculation. In one embodiment the duration of disconnect is two and a half seconds, and may be shorter or longer depending on the requirements of the electronic device 102. During the period of disconnection described above, resistor 401 may be sized to provide a small current to the input of the electronic device 102 to prevent deactivation of the power circuitry 103 in the electronic device. Hence, use of the term disconnect or disconnection herein can include a period where the majority of power is disconnected but such a small current is provided to the electronic device 102 to prevent deactivation of the certain circuitry, such as power circuitry 103, in the electronic device. In one embodiment, use of the term disconnect or disconnection herein includes a period where sufficient power is disconnected from the electronic device to cause the electronic device to reset and thereafter receive power at a higher level. When the period of disconnection is over, full available current is restored to the electronic device 102 through transistor 402.

In one exemplary operation of apparatus 200, incident power 251 from variable power supply 100 is initially provided to electronic device 102 at a level where variable voltage VT is below the threshold power level of device 102 that correlates to junction voltage 304a. The power circuitry 103 of electronic device 102 locks into such power level, for example by locking into a current level, and initiates drawing current at such level from apparatus 200. Absent apparatus 200, electronic device 102 may continue drawing current at the initial current level despite an increase in the available power being supplied by variable power supply 100. In contrast, when the incident power 251 from power supply increases above a preset power threshold of apparatus 200, for example by the incident power 251 or incident current from the power supply 100 increasing above a predetermined power or current threshold of apparatus 200, electronic circuit 220 effectively disconnects the power supply 100 from the electronic device 102 for a short or predetermined period of time and then reconnects the power supply 100 to the electronic device so that a higher level of incident power is provided to the device 102 upon such reconnection.

As is known to those skilled in the art, upon re-establishing the charging connection, an electronic device 102 being charged by a power source, such as power source 100, may automatically attempt to access a highest available current at a predetermined voltage, commonly 5V as dictated by USB standard. If the available power does not meet the power requirements of the device under charge, the output voltage level of the charger may drop to obtain the highest available current for charging, and in some instances the voltage may drop below minimum thresholds defined by the power circuitry 103 and the battery 104 of the electronic device 102.

In one embodiment of the invention, electronic circuit 220 includes circuitry for regulating any drop in the voltage being provided by apparatus 200 to the electronic device 201. In one embodiment, GVD circuitry 210 can include sensing circuitry for sensing a drop in the input voltage being supplied by the power source 100 to the electronic device 102 in response to the power management circuitry of the electronic device and voltage regulation circuitry for limiting the rate of drop of voltage being supplied to the electronic device in response to the sensed drop in the input voltage. In this regard, upon reconnection of the full available current from electronic circuit 220 to the electronic device 102 as described above, power 251 from the power supply 100 may be further modified by the gradual voltage drop circuitry 210 provided in electronic circuit 220. Such gradual voltage drop circuitry can also be referred to as voltage drop, voltage scan, power level drop or power level scan circuitry. In one embodiment, components 201-209 in FIG. 3. comprise GVD circuitry 210. The GVD circuitry can prevent rapid voltage drop signaled by electronic devices 102, instead gradually reducing the voltage provided by electronic circuit 220 until the requirement of electronic device 220 is equal to or less than available power 251 being provided by the power source 100, at which point the voltage drop stops.

In one embodiment, the GVD circuitry 210 is comprised of a set of capacitors, resistors, amplifiers and electrical components 201-209 that condition the voltage scan of the electronic device 102 through an adjustment point on a switch mode regulator 201. In one embodiment, regulator is included in voltage boost circuitry 250, and includes an input for receiving the incident power 251 provided by power supply 100. In one embodiment, the output voltage of regulator is set to 5V when the incident power 251 be provided to regulator 201, VIN in FIG. 3, is with a certain range. Without GVD circuitry 210, when VIN to regulator 201 drops or collapses to a certain level, the output voltage of the regulator 201 similarly collapses. GVD circuitry 210 provides that as the input voltage into regulator 201 drops, the voltage drop is sensed by the lower operational amplifier in operational amplifier set 206, which then functions as an inverter and outputs a high voltage. Resistors 204 and 205 form a voltage divider and feed a fraction of the inverted high voltage output from the lower amplifier 206 to a feedback pin on regulator 201. Such high voltage input to regulator 201 compensates against the drop in the VIN input to regulator 201 and causes the regulator 201 to output a higher voltage than would be dictated by the collapsed VIN input. At some point, the output voltage of regulator 201 dictated by such high voltage input signal to the regulator coalesces with the output voltage of regular 201 that would be dictated by VIN absent such high voltage input signal. By this process the voltage from electronic circuit 220 drops until the voltage input recovers. The GVD circuitry 210 may also be configured to scan for variable current levels. In one embodiment the setting for maximum voltage is 5V, and the setting for minimum voltage is around 3.3 V.

The apparatus of the invention can be used with any suitable power supply 100, which can include a variable power supply and a variable electrical power supply. In one embodiment of the innovation, the apparatus of the invention, the apparatus of the invention is integrated into a portable electricity generating device of any suitable type, such as any of the devices disclosed in U.S. publication number US-2014-0026933 that published on Jan. 30, 2014. The entire contents of U.S. publication number US-2014-0026933 are incorporated herein by this reference. An exemplary portable electricity generating device or apparatus, illustrated in FIGS. 6 and 7, is an apparatus for generating electrical energy from an open flame or other heat source. Apparatus 600 may include a thermally-conductive element 610, also referred to herein as thermally-conductive member 610, a thermoelectric apparatus or device 620 disposed in a suitable housing 622, and a heat sink 630. Heat sink 630 may be of any suitable type and in one embodiment is a reservoir or bath 632 extending above the housing 622 and having a top opening 633 for placing a suitable liquid in the reservoir. The thermally conductive member 610 may be of any suitable size and shape and in one embodiment is formed from a planar element 612 made from any suitable heat conductive material such as metal. The planar element 612 may be a unitary member, for example a monolith, made from the same continuous material, for example a block or a sheet of metal. The planar element 612 may include a first or exposed portion 614 and an opposite second or enclosed portion 616. The exposed portion 614 may extend outward or forwardly from the housing 622 for placement of the exposed portion 614 in contact with a suitable heat source. All or a portion of second portion 616 may be enclosed within the housing 622.

The thermoelectric device or apparatus 620 may be of any suitable type, for example a Peltier device. Apparatus may include a first or hot surface 623 and an opposite second or cold surface 624. While only one thermoelectric device 622 is depicted in FIGS. 6 and 7, apparatus 600 may include any number of individual devices 622 arranged within the housing 622 in any suitable manner.

Housing 622 may enclose at least a portion of the thermally conductive member 610, for example second portion 616, which portion may be provided in direct physical contact with the hot surface 623 of thermoelectric device 620. Housing 622 may be a unitary component or it may be assembled from a plurality of components. For example, the housing 622 may include a first or top housing component 626 and a second or bottom housing component 627, which may be secured together by any suitable means such as one or more fasteners 628. In one embodiment, only a top housing component 626 is provided. The thermally conductive member 610 may be removably or non-removably attached to thermoelectric device 620. In one embodiment, member 610 is fixedly or non-removably attached to thermoelectric device 620 and housing 622. Apparatus 600 may include a retention element or retainer 631, which may be configured to contact all or a portion of the second portion 616 of member 610 and press the member 610 against the thermoelectric device 620. Reservoir 632 can be secured to housing 622 by any suitable manner, and directly or indirectly contact cold surface 624 of the thermoelectric device 620. In one embodiment, reservoir 632 is formed at least in part by a flexible plastic material that is movable between a first or contracted configuration for storage and a second or expanded configuration for operation.

The apparatus 600 includes a cable 636 carrying at least first and second electrical leads or wires 637. Cable includes a first portion 638 joined to housing 622, with first and second wires 637 respectively coupled by any suitable means to the hot surface 623 and the cold surface 624 of thermoelectric apparatus 620. Cable 636 includes a second portion 639 which terminates at apparatus 200 having connector 225 for interfacing with portable electronic device 102.

In operation and use of apparatus 600, thermally conducting member 610 can be placed in an open flame, like a cooking fire, and conduct the heat energy to hot side 623 of the thermoelectric generator or device 620. The opposite cold side 624 of the thermoelectric generator 620 is in thermal contact with water bath or reservoir 632, which water bath serves as a cooling medium for the thermoelectric device 620. The temperature difference across the thermoelectric generator 620 creates power, which power is delivered to apparatus 200 for charging portable electronic device 102. In one embodiment, the power curve or IV curve of the thermoelectric device or module 620 may be used to correlate the voltage to the current generated by the thermoelectric module, which voltage may be scanned by GVD circuitry 210 as described above as a means to track the current output from the power source or device 620.

It is appreciated that the apparatus of the invention can be utilized with any power supply or source for providing power to an electronic device. Such suitable supplies or sources include a variable electrical power supply or source, a variable electrical energy supply or source or any electrical supply or source that provides a power output that varies in voltage, current or both. Exemplary power sources include heat and fire powered generators, photovoltaic cells, solar cells, other solar-powered electricity generating solar devices, wind-powered electricity generating devices, generators utilizing flowing water or kinetic motion, and fuel cells. Any of such power supplies or sources can be included with the apparatus of the invention in a device, for example similar to how the apparatus of the invention and power supply 620 are included in device 600. Thus, for example, a device utilizing the apparatus of the invention and a solar power supply, a wind power supply, a fluid motion power supply or any of the other variable power supplies disclosed herein could be provided. The power provided by the apparatus of the invention can be utilized for any suitable purpose, including operating the electronic device, charging any battery of the electronic device or both.

In one embodiment of the invention, an electronic circuit for use with a variable electrical power source providing input power for use by an electronic device having power management circuitry with specified input power level requirements is provided. The circuit can include comparison circuitry for providing at least one transition power characteristic threshold and for comparing the input power to the at least one transition power characteristic threshold and switching circuitry for disconnecting and then reconnecting the power supply to the electronic device when the input power exceeds the at least one transition power characteristic threshold.

The comparison circuitry can include circuitry for providing at least one transition power threshold and for comparing the input power to the at least one transition power threshold and the switching circuitry includes circuitry for disconnecting and then reconnecting the power supply to the electronic device when the input power exceeds the at least one transition power threshold. The comparison circuitry can include circuitry for providing at least one transition current threshold and for comparing the current component of the input power to the at least one transition current threshold and the switching circuitry includes circuitry for disconnecting and then reconnecting the power supply to the electronic device when the current component of the input power exceeds the at least one transition current threshold. The electronic circuit can further include available power measurement circuitry for dynamically detecting the voltage and current being provided by the variable electrical power source. The available power measurement circuitry can include calculation circuitry for providing a calculated voltage that correlates to the input power being supplied by the variable electrical power source. The calculation circuitry can be configured to utilize voltage and current components of the input power for providing the calculated voltage that correlates to the input power. The comparison circuitry can include circuitry for providing a reference voltage as the at least one transition power characteristic threshold and for comparing the calculated voltage to the reference voltage and the switching circuitry can include circuitry for disconnecting and then reconnecting the power supply to the electronic device when the calculated voltage exceeds the reference voltage. The electronic circuit can further include voltage regulation circuitry for limiting the rate of drop of voltage being supplied to the electronic device in response to the power management circuitry of the electronic device. The electronic circuit can be combined in a suitable device with a variable electrical power source. The variable electrical power source can be of any suitable type, including heat and fire powered generators, photovoltaic cells, solar cells, solar-powered electricity generating solar devices, wind-powered electricity generating devices, generators utilizing flowing water or kinetic motion and fuel cells.

In one embodiment, an electronic circuit for use with a variable electrical power source providing input voltage and input current for use by an electronic device having power management circuitry is provided. The circuit can include sensing circuitry for sensing a drop in the input voltage being supplied by the power source to the electronic device in response to the power management circuitry of the electronic device and voltage regulation circuitry for limiting the rate of drop of voltage being supplied to the electronic device in response to the sensed drop in the input voltage.

The voltage regulation circuitry can include an operational amplifier for receiving the input voltage and having an output electrically coupled to a feedback pin of a regulator, the regulator having an input for receiving the input voltage.

In one embodiment, an electronic circuit for use with a variable electrical power source providing variable power having a variable voltage component and a variable current component for use by an electronic device is provided. The circuit can include electrical circuitry for controlling the variable voltage component at a set voltage level, electrical circuitry for monitoring the variable current component, an electrical switch for disconnecting and connecting current being delivered to the electronic device based on the monitored current, and electrical circuitry for controlling the rate of change of the variable voltage component from the power supply.

The electrical circuitry and the electrical switch can each include analog circuit components installed on a printed circuit board. The electrical circuitry and the electrical switch can be provided in at least one integrated circuit.

From the foregoing it will be appreciated that, although specific embodiments of the invention have been described herein for purposes of illustration, various modifications may be made without deviating from the spirit and scope of the invention.

I claim:

1. An electronic circuit for use with a variable electrical power source providing input power for use by an electronic device having power management circuitry with specified input power level requirements, comprising comparison circuitry for providing at least one transition power characteristic threshold and for comparing the input power to the at least one transition power characteristic threshold and switching circuitry for disconnecting and then reconnecting the power supply to the electronic device when the input power exceeds the at least one transition power characteristic threshold.

2. The electronic circuit of claim 1 wherein the comparison circuitry includes circuitry for providing at least one transition power threshold and for comparing the input power to the at least one transition power threshold and the switching circuitry includes circuitry for disconnecting and then reconnecting the power supply to the electronic device when the input power exceeds the at least one transition power threshold.

3. The electronic circuit of claim 1 for use with a variable electrical power source to provide input power having a current component, wherein the comparison circuitry includes circuitry for providing at least one transition current threshold and for comparing the current component of the input power to the at least one transition current threshold and the switching circuitry includes circuitry for disconnecting and then reconnecting the power supply to the electronic device when the current component of the input power exceeds the at least one transition current threshold.

4. The electronic circuit of claim 1, further comprising available power measurement circuitry for dynamically detecting the voltage and current being provided by the variable electrical power source.

5. The electronic circuit of claim 4, wherein the available power measurement circuitry includes calculation circuitry for providing a calculated voltage that correlates to the input power being supplied by the variable electrical power source.

6. The electronic circuit of claim 5 for use with an input power having voltage and current components, wherein the calculation circuitry is configured to utilize the voltage and current components of the input power for providing the calculated voltage that correlates to the input power.

7. The electronic circuit of claim 5 wherein the comparison circuitry includes circuitry for providing a reference voltage as the at least one transition power characteristic threshold and for comparing the calculated voltage to the reference voltage and the switching circuitry includes circuitry for disconnecting and then reconnecting the power supply to the electronic device when the calculated voltage exceeds the reference voltage.

8. The electronic circuit of claim 1, further comprising voltage regulation circuitry for limiting the rate of drop of voltage being supplied to the electronic device in response to the power management circuitry of the electronic device.

9. The electronic circuit of claim 1 in combination with the variable electrical power source.

10. The electronic circuit of claim 9 wherein the variable electrical power source is a power source selected from the group consisting of heat and fire powered generators, photovoltaic cells, solar cells, solar-powered electricity generating solar devices, wind-powered electricity generating devices, generators utilizing flowing water or kinetic motion and fuel cells.

11. An electronic circuit for use with a variable electrical power source providing input voltage and input current for use by an electronic device having power management circuitry, comprising sensing circuitry for sensing a drop in the input voltage being supplied by the power source to the electronic device in response to the power management circuitry of the electronic device and voltage regulation circuitry for limiting the rate of drop of voltage being supplied to the electronic device in response to the sensed drop in the input voltage.

12. The electronic circuit of claim 11, wherein the voltage regulation circuitry includes an operational amplifier for receiving the input voltage and having an output electrically coupled to a feedback pin of a regulator, the regulator having an input for receiving the input voltage.

13. An electronic circuit for use with a variable electrical power source providing variable power having a variable voltage component and a variable current component for use by an electronic device, comprising electrical circuitry for controlling the variable voltage component at a set voltage level, electrical circuitry for monitoring the variable current component, an electrical switch for disconnecting and connecting current being delivered to the electronic device based on the monitored current, and electrical circuitry for controlling the rate of change of the variable voltage component from the power supply.

14. The electronic circuit of claim 13, wherein the electrical circuitry and the electrical switch each include analog circuit components installed on a printed circuit board.

15. The electronic circuit of claim 13, wherein the electrical circuitry and the electrical switch are provided in at least one integrated circuit.
